(19) United States
(12) Patent Application Publication
(10) Pub. No.: US 2010/0049533 A1
(43) Pub. Date: Feb. 25, 2010

(54) Executing an Energy Transaction Plan for an Electric Vehicle

(75) Inventors: Erica Haefner Ferro, Boulder, CO (US); Colin George Harrison, Brookfield, CT (US); Mark William Trekell, Aurora, CO (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/194,245

(22) Filed: Aug. 19, 2008

(51) Int. Cl. G06Q 50/00

(52) U.S. Cl. 705/1

(57) ABSTRACT

A computer implemented method, apparatus, and computer usable program code for managing a charging process of an electric vehicle. In one embodiment, the process initiates the charging process of the electric vehicle at a charging station in response to receiving an energy transaction plan from an energy transaction planner. The process then terminates the charging process in response to at least one of a deviation of the charging process from the energy transaction plan and a completion of the charging process according to the energy transaction plan. Thereafter, the process sends a charge notification to a set of recipients that includes a user of the electric vehicle and an energy transaction broker.

### BACKGROUND OF THE INVENTION

1. Field of the Invention

The present invention is related generally to an improved data processing system, and in particular, to a method and apparatus for managing electric vehicle charging transactions. More particularly, the present invention is directed to a computer implemented method, apparatus, and computer usable program code for an energy transaction execution engine for executing an energy transaction plan for an electric vehicle.

2. Description of the Related Art

Electric vehicles (EV) can be divided into two categories: totally electric vehicles (TEV) and plug-in hybrid electric vehicles (PHEV). Plug-in hybrid vehicles utilize two or more power sources to drive the vehicle. With the increasing costs of fossil fuels and concern over reliance on non-renewable resources, electric vehicles are poised to become a critical component of transportation systems throughout the world. Gasoline powered vehicles utilize the explosive power of a mixture of gasoline and air to propel the vehicle. In contrast, electric vehicles rely in whole or in part on electric power to drive the vehicle.

Electric vehicles contain electric storage mechanisms, such as batteries, to store electricity until it is needed to power the electric vehicle. The electric storage mechanisms require periodic charging to replenish the electric charge for continued operation. The electricity used to charge the electric storage mechanisms may be provided by any type of on-vehicle power generation and charging mechanism. The on-vehicle power generation and charging mechanisms may include consumptive power generation systems and/or non-consumptive power generation systems, such as, without limitation, fuel cells, gasoline powered combustion engines, biodiesel powered engines, solar powered generators, and regenerative braking systems.

In totally electric vehicles and plug-in hybrid electric vehicles, charging of the electric vehicles can also be accomplished by plugging the electric vehicle into an off-vehicle charging station. The off-vehicle charging station provides an external source of electricity, such as, an electric power grid. Totally electric vehicles require this type of off-vehicle charging in all cases. Off-vehicle charging is also likely to be significantly less expensive for plug-in hybrid electric vehicles than on-vehicle charging given currently available technology. Consequently, off-vehicle charging may be the preferred charging mode for electric vehicle owners.

The power stored in the electric storage mechanisms on the electric vehicles and on-vehicle power generation mechanisms may be used to provide electricity back to the electricity grid. For electric vehicles to be used as suppliers of electric power to an electric power grid, electric vehicles are connected to an off-vehicle infrastructure, which can efficiently consume the electricity generated or stored by the electric vehicle. To date, electric vehicle manufacturers and electric utility companies have only planned and provided infrastructure and methods for the most rudimentary charging scenario in which the electric vehicle is plugged into a common electric outlet.

### BRIEF SUMMARY OF THE INVENTION

According to one illustrative embodiment, a computer implemented method, apparatus, and computer usable program code is provided for managing a charging process of an electric vehicle. In one embodiment, the process initiates the charging process of the electric vehicle at a charging station in response to receiving an energy transaction plan from an energy transaction planner. The process then terminates the charging process in response to at least one of a deviation of the charging process from the energy transaction plan and a completion of the charging process according to the energy transaction plan. Thereafter, the process sends a charge notification to a set of recipients that includes a user of the electric vehicle and an energy transaction broker.

### BRIEF DESCRIPTION OF THE SEVERAL VIEWS OF THE DRAWINGS

FIG. 1 is a pictorial representation of a network data processing systems in which illustrative embodiments may be implemented;

FIG. 2 is a block diagram of a data processing system in which illustrative embodiments may be implemented;

FIG. 3 is a block diagram of an energy transaction infrastructure in accordance with an illustrative embodiment;

FIG. 4 is a block diagram of a system for executing an energy transaction plan in accordance with an illustrative embodiment;

FIG. 5 is a block diagram of an energy transaction plan in accordance with an illustrative embodiment;

FIG. 6 is a flowchart of a process for executing an energy transaction plan in accordance with an illustrative embodiment;

FIG. 7 is a flowchart of a process for sending a completed charge notification in accordance with an illustrative embodiment; and

FIG. 8 is a flowchart of a process for transmitting an incomplete charge notification in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

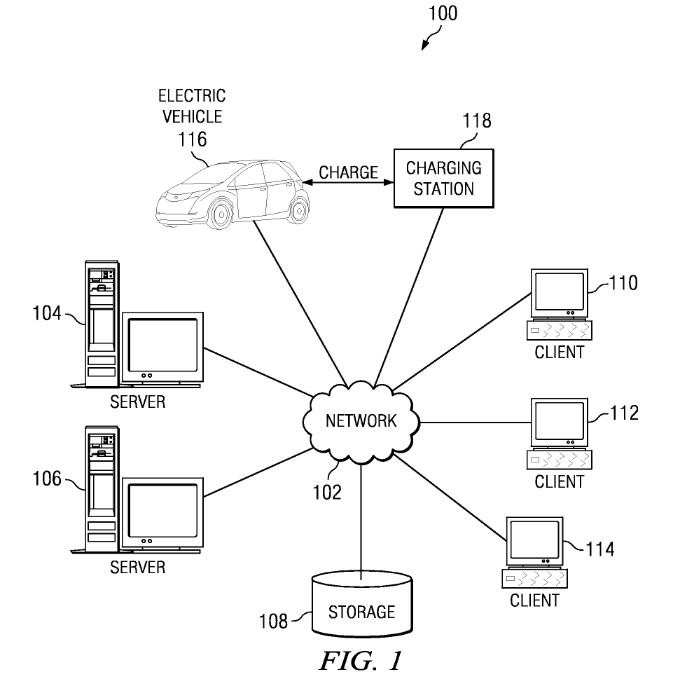

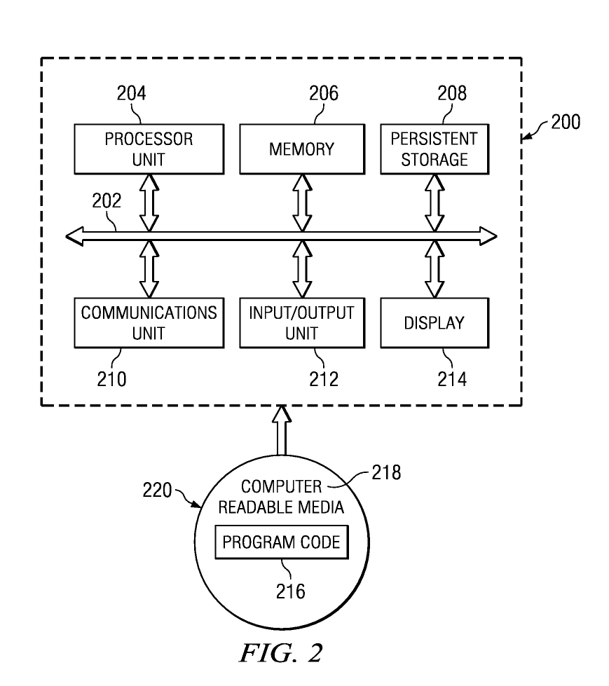

With reference now to the figures, and in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network data processing system in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Electric vehicle 116 is any vehicle that utilizes electric power, in whole or in part, to drive the vehicle that is capable of being plugged into charging station 118. Electric vehicle 116 may be a totally electric vehicle or a plug-in hybrid electric vehicle. The plug-in electric hybrid vehicle may be a gasoline/electric hybrid, a natural gas/electric hybrid, a diesel/electric hybrid, a biodiesel/electric hybrid, or any other type of plug-in electric hybrid. Electric vehicle 116 may optionally include an on-vehicle power generation mechanism such as, but without limitation, solar power electric generators, gasoline powered electric generators, biodiesel powered electric generator, or any other type of on-vehicle electric power generation mechanism.

Charging station 118 is any station, kiosk, garage, power outlet, or other facility for providing electricity to electric vehicle 116. Electric vehicle 116 receives electricity from, or provides electricity to, an electric grid at charging station 118. Charging station 118 is a selected charge/discharge site, such as an outlet or kiosk, for providing electric vehicle 116 with access to the electric grid. For example, and without limitation, charging station 118 may be a power outlet in a privately owned garage, an electric outlet in a docking station in a commercially owned electric vehicle charging kiosk, or a power outlet in a commercially owned garage.

Electric vehicle 116 connects to charging station 118 via an electrical outlet or other electricity transfer mechanism. The electricity may also be optionally transferred via wireless energy transfer, also referred to as wireless power transfer, in which electrical energy is transferred to a load, such as electric vehicle 116, without interconnecting wires. The electricity may flow from charging station 118 into electric vehicle to charge electric vehicle 116. The electricity may also flow from electric vehicle 116 into charging station 118 to sell electricity back to the power grid.

Electric vehicle 116 and charging station 118 are optionally connected to network 102. Electric vehicle 116 and charging station 118 send and receive data associated with the charging of electric vehicle, the capabilities of electric vehicle, the capabilities of charging station 118, the current charge stored in electric vehicle, the rate of charging electric vehicle, the price of electricity received from a power grid, identity of the owner and/or operator of electric vehicle 116 and/or any other data relevant to charging or de-charging electric vehicle 116 over network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. Data processing system 200 may also be implemented as a computing device on-board an electric vehicle, such as electric vehicle 116 in FIG. 1.

In this illustrative example, data processing system 200 includes communications fabric 202, which provides communications between processor unit 204, memory 206, persistent storage 208, communications unit 210, input/output (I/O) unit 212, and display 214. Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. In another example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Currently, electric vehicle manufacturers and electric utility companies have only planned and provided infrastructure for the most rudimentary charging scenarios, such as, merely plugging the electric vehicle into a common electric outlet that is owned by the owner and operator of the electric vehicle. The illustrative embodiments recognize that charging electric vehicles will frequently be conducted under much broader and more complex sets of circumstances than this simple scenario and infrastructure is needed to accommodate these complex transactions. For example, owners and operators of electric vehicles will frequently be required to charge their electric vehicle at a charging station that is remote from the home of the electric vehicle owner. In most circumstances, it is unlikely that the electric vehicle owner will own the off-vehicle charging stations from which the owner obtains electricity to recharge the electric vehicle. In such a situation, the owner or operator of the electric vehicle will likely be required to pay for the charge obtained from the off-vehicle charging station.

The illustrative embodiments recognize that the charging transactions by which electric vehicles obtain electricity from an off-vehicle charging station to charge the electric vehicle requires a much more complete, flexible, and interoperable system governing all aspects of the charging transaction. Electric vehicle charging transactions can be divided into the pre-charge phase, the charge phase, and the post-charge phase. During the pre-charge phase of decision enablement, all parties are presented with the conditions governing the charging transaction. Electricity flows to the electric vehicle and payment is made during the post-charge phase. Finally, during the post-charge phase of the transaction, an analysis is performed to provide incentives and induce specific behaviors on the part of any party involved in the transaction. Additional charging infrastructure may also be provided to meter electricity at the point of charge, identify the various parties involved in the transaction, and provide flexible business rules governing the flow of funds between those parties.

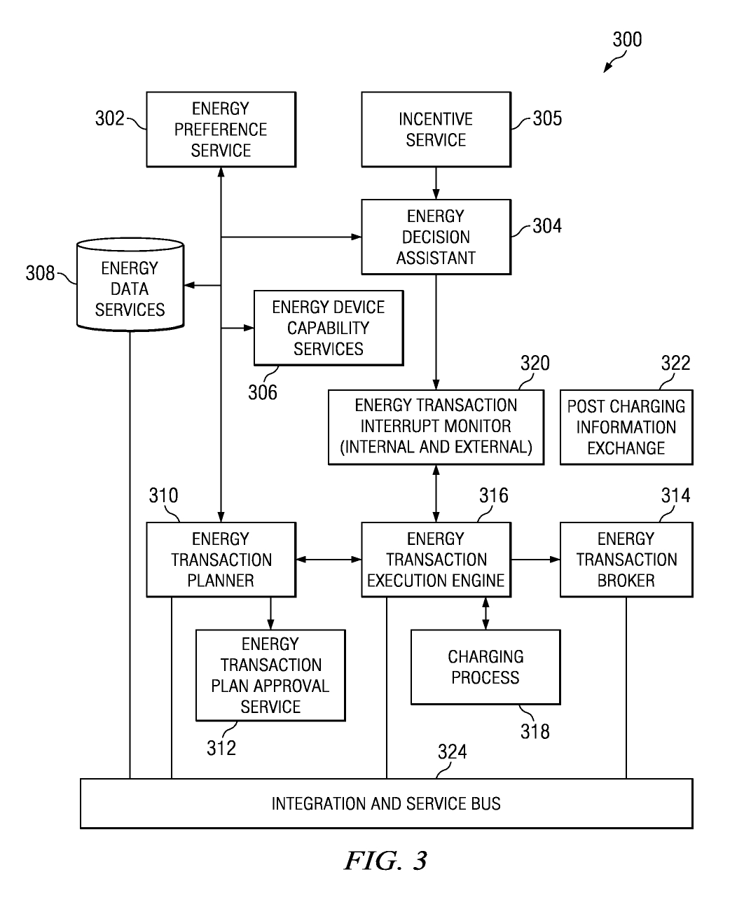

FIG. 3 is a block diagram of an energy transaction infrastructure in accordance with an illustrative embodiment. Electric vehicle energy transaction infrastructure 300 is a charging infrastructure for managing all phases of an electric vehicle charging transaction. The components of electric vehicle energy transaction vehicle charging infrastructure 300 include components that may be found in a network data processing system, such as network data processing system 100 in FIG. 1. For example, preference services or data services of electric vehicle energy transaction vehicle charging infrastructure 300 may be hosted in a server, such server 104 in FIG. 1.

During the pre-charge phase, all parties of the transaction are presented with the conditions governing the charging transaction. The parties may include, without limitation, the owner of the electric vehicle to be charged, the operator of the electric vehicle, the owner of the charging station, and an electric utility company providing electricity to an electric power grid associated with the charging station. Parties agree to conditions relevant to their role in the transaction prior to the charge commencing. There are likely to be many special circumstances in the terms and conditions, which are presented in standard formats which are universally understood and which can be readily communicated and agreed upon by all parties.

During the pre-charge phase, electric vehicle energy transaction infrastructure 300 utilizes energy preference service 302, energy decision assistant 304, energy device capability services 306, energy data services 308, energy transaction planner 310, and optionally, energy transaction plan approval service 312 to generate a plan governing the charging transaction to the parties involved in the transaction.

Energy preference service 302 is a software component that generates, stores, and retrieves preference information associated with an electric vehicle and the preference information associated with the parties to the transaction. Preferences may include, without limitation, a maximum price per kilowatt hour of electricity to be paid by a party, a location where charging may occur, a location where charging may not occur, a rate of charging the electric vehicle, a minimum amount of charge, or any other preferences associated with charging an electric vehicle. The preferences may be pre-generated by one or more of the parties to the transaction.

Energy decision assistant 304 is an optional service that provides real-time options and trade-offs for a particular trip. For example, energy decision assistant 304 may monitor available incentives, weather conditions, a travel route, traffic information, and other real-time data to identify the best electric vehicle charging options for a particular trip.

Incentive service 305 receives offers of incentives from third party vendors. The incentives may be offers of discounts, rebates, rewards, and/or other incentives associated with charging an electric vehicle to encourage an operator of the electric vehicle to perform one or more behaviors associated with charging the electric vehicle. For example, and without limitation, an incentive may offer to charge the electric vehicle for free at a particular charging station if the owner or operator of the electric vehicle purchases one or more products from the third party vendor. Incentive service 305 provides information describing current incentives to energy transaction planner 310. In one embodiment, incentive service 305 provides the information describing the incentives to energy decision assistant 304. Energy decision assistant 304 then provides the incentives information to energy transaction planner 310.

Energy device capability services 306 is a software component that identifies and validates device capabilities. For example, and without limitation, energy device capability services 306 may include information describing the charging capabilities of the charging station, the charging requirements of the electric vehicle, the maximum storage capacity of the electric vehicle on-vehicle storage mechanisms, the existing amount of charge in the electric vehicle, the number of amps of electricity the charging station is capable of providing, and any other information associated with the capabilities and requirements of the electric vehicles and the charging station.

Energy data services 308 are a set of one or more third party data sources providing information relevant to the energy transaction. Energy data services 308 may include, without limitation, weather information sources, traffic information sources, map and travel information sources, charging station price information sources, or any other third party information sources.

Energy transaction planner 310 is an application that creates a transaction plan for governing the electric vehicle charging transaction based on preferences of one or more principals. Energy transaction plan approval service 312 approves the transaction plan and validates with energy transaction broker 314. Energy transaction plan approval service 312 may be required to notify one or more parties of the terms of the transaction and obtain approval of one or more of the terms from the party. For example, and without limitation, if an operator of the electric vehicle is not the owner of the electric vehicle, energy transaction plan approval service 312 may require approval from the owner of the vehicle before allowing the vehicle to receive power at a charging station if the charging station and/or a utility will charge the owner of the electric vehicle a fee for the charging transaction.

In this example, the charging phase begins when energy transaction execution engine 316 receives a plan from the energy transaction planner 310. Thereafter, the energy transaction execution engine 316 initiates charging process 318 for charging the electric vehicle. Charging process 318 is a series of related events or conditions in an exchange of electricity between the electric vehicle and charging station. The activities of charging process 318 may include, for example, identification of parties and preferences, authenticating data, storing data, analyzing data, or any other event or condition that is directly related to or incidental to the exchange of electricity between the vehicle and the utility grid. In the simplest form, charging process 318 involves a flow of electricity into the electric vehicle from the power grid or out of the electric vehicle and back into the power grid. Energy transaction execution engine 316 then monitors and logs the health and safety of charging process 318, and receives interrupt notifications from energy transaction interrupt monitor 320.

Energy transaction interrupt monitor 320 monitors data transmissions and conditions that result from the execution of charging process 318 to detect interrupt conditions that may terminate the flow of electric power to or from a vehicle. The interrupts may originate from the power grid, suppliers, and/or vehicles. For example, if a price of energy exceeds a predefined threshold in violation of a user-selected preference, energy transaction interrupt monitor 320 detects this interrupt condition and initiates appropriate actions to handle the cessation of electric power flow to the electric vehicle.

Energy transaction broker 314 supports settling electric vehicle charging and discharging transactions independent of electricity supplier, parking space supplier, charging facility electrical infrastructure supplier, taxing authority, incentive provider, or other interested party. Elements include but are not limited to pricing schedules, time based pricing, facility recovery, tax collection, incentives, and/or fixed plans. Energy transaction broker 314 may also be used by energy transaction plan approval service 312 to validate the financial elements of the energy transaction plan prior to plan approval and prior to charging the electric vehicle.

The post-charge phase comprises analysis of the completed energy transaction to provide incentives, redeem credits or benefits, and induce specific behaviors by one or more parties involved in the charging transaction. The post-charge phase also includes payment of the appropriate parties for the energy transaction in accordance with the energy transaction plan governing the transaction. Various programs may be available to incent specific behaviors on the part of consumers. For example, a vehicle owner or user may receive reduced electricity rates if vehicle charging is conducted during off-peak times, such as during the night rather than during daylight hours when electricity usage is higher. Post charging information exchange 322 accumulates data pertinent to these incentives or redemption programs, authenticates the incentives data, and analyzes the incentives data to identify the most effective business process and optimize incentives for the parties.

Operational and financial parameters are conveyed for an optimum charge to occur. For example, a dynamic representation of an electric vehicle capability to consume charge should be understood at all times during the charging process to ensure the vehicle is not damaged or that the protections of the charging system are preserved. Electricity metering of the power flow may also be conducted and reported. Standards representing the acceptable charging voltage and amperage ranges, for example may be communicated and maintained for a safe charging transaction to occur. All data pertinent to the financial transaction is conveyed and recorded.

The components shown in FIG. 3 may be implemented on a data processing system associated with an electric vehicle. In such case, the components communicate and transfer data using integration and service bus 324. Integration and service bus 324 is an internal communication system within the electric vehicle, such as any wired or wireless communications system. A wired communications system includes, without limitation, a data bus or a universal serial bus (USB). If one or more components shown in FIG. 3 are located remotely, the components may transfer data using any type of wired or wireless network connection to connect to a network, such as network 102 in FIG. 1. A wireless network connection may be implemented over a cell-phone network, satellite, two-way radio, WiFi networks, or any other type of wireless network.

The illustrative embodiments discuss an energy transaction execution engine that controls a charging process for an electric vehicle. The charging process may be the charging of a battery of the electric vehicle or the transmission of electricity from the electric vehicle to a power grid. The energy transaction execution engine insures that the charging process proceeds according to the terms of an energy transaction plan to which parties have already agreed. The energy transaction execution engine may start the charging process when an energy transaction plan is received, and terminate the charging process when either the terms of the energy transaction plan have been satisfied or when the electric vehicle is fully charged or discharged. In addition, the energy transaction execution engine has the ability to prematurely terminate a charging process in the event that the charging process deviates from the guidelines of the energy transaction plan. Premature termination of the charging process by the energy transaction execution engine may protect the integrity of components of an electric vehicle transaction infrastructure. For example, dangerous conditions that arise from malfunctioning components, if detected, may result in the termination of the charging process to prevent the dangerous condition from further escalating and causing irreparable harm to components of the electric vehicle transaction infrastructure.

According to one embodiment, a computer implemented method, apparatus, and computer usable program code is provided for managing a charging process of an electric vehicle. In one embodiment, the process initiates the charging process of the electric vehicle at a charging station in response to receiving an energy transaction plan from an energy transaction planner. The process then terminates the charging process in response to at least one of a deviation of the charging process from the energy transaction plan and a completion of the charging process according to the energy transaction plan. As used herein the phrase “at least one of” when used with a list of items means that different combinations one or more of the items may be used and only one of each item in the list may be needed. For example, “at least one of item A, item B, and item C” may include, for example, without limitation, item A or item A and item B. This example also may include item A, item B, and item C or item B and item C. In other words, the process may terminate if the process detects either a deviation of the charging process from the energy transaction plan, a completion of the charging process according to the energy transaction plan, or both.

Thereafter, the process sends a charge notification to a set of recipients. The term “set” refers to one or more, unless otherwise indicated herein. For example, the set of recipients may include a single recipient, as well as two or more recipients. The notification includes a user of the electric vehicle and an energy transaction broker.

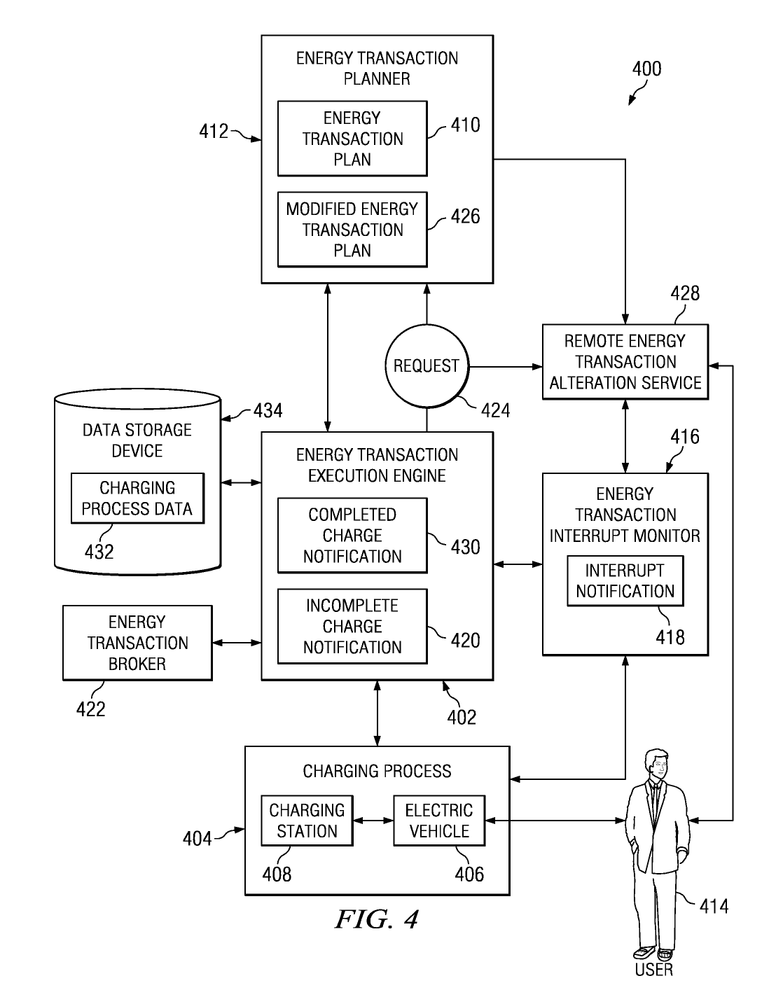

FIG. 4 is a block diagram of a system for executing an energy transaction plan in accordance with an illustrative embodiment. System 400 is a system, such as network data processing system 100 in FIG. 1. System 400 may include or be incorporated into an electric vehicle energy transaction infrastructure such as electric vehicle energy transaction infrastructure 300 in FIG. 3.

System 400 includes energy transaction execution engine 402. Energy transaction execution engine 402 is an energy transaction execution engine such as energy transaction execution engine 316 in FIG. 3. More specifically, energy transaction execution engine 402 is a software component for controlling the execution of charging process 404. Charging process 404 is a charging process such as charging process 318 in FIG. 3. Charging process 404 is the process by which electricity is transferred between electric vehicle 406 and charging station 408. Charging process 404 may include other events directly or indirectly related to the transfer of electricity between electric vehicle 406 and charging station 408. For example, charging process 404 may include the transfer and storage of data describing charging process 404, the allocation of incentives or benefits related to the transfer of electricity, the identification of parties and preferences, the authenticating data, or any other event.

Electric vehicle 406 is an electric vehicle such as electric vehicle 116 in FIG. 1. Similarly, charging station 408 is a charging station such as charging station 118 in FIG. 1. During charging process 404, electric vehicle 406 may receive electricity. Alternatively, electric vehicle 406 may transmit electricity to charging station 408 for providing power to a power grid.

Energy transaction execution engine 402 executes charging process 404 according to energy transaction plan 410. Energy transaction plan 410 is a set of guidelines for executing charging process 404. For example, energy transaction plan 410 may specify rules regarding, a source of electricity, a type of payment, an amount of electricity, a maximum cost for a charging transaction, or any other parameter that may be relevant to charging process 404.

Energy transaction plan 410 is generated by energy transaction planner 412. Energy transaction planner 412 is an energy transaction planner such as energy transaction planner 310 in FIG. 3. Energy transaction planner 412 generates energy transaction plan 410 from preferences and other forms of input received from the parties to a charging transaction. The parties to the charging transaction may include user 414, utility companies, third party vendors, or other interested parties.

Energy transaction execution engine 402 receives energy transaction plan 410 from energy transaction planner 412. In response, energy transaction execution engine 402 initiates charging process 404 by notifying charging station 408 to start collecting electricity from or sending electricity to electric vehicle 406. At that time, energy transaction execution engine 402 may also request the services of energy transaction interrupt monitor 416. Energy transaction interrupt monitor 416 is an energy transaction interrupt monitor, such as energy transaction interrupt monitor 320 in FIG. 3. Energy transaction interrupt monitor 416 monitors charging process 404 to insure that charging process 404 is proceeding according to energy transaction plan 410. If energy transaction interrupt monitor 416 detects an event or condition of charging process 404 that violates the guidelines established in energy transaction plan 410, energy transaction interrupt monitor 416 may notify energy transaction execution engine 402 of the violation. Energy transaction execution engine 402 may then terminate charging process 404.

Energy transaction interrupt monitor 416 notifies energy transaction execution engine 402 of any violation of energy transaction plan 410 by generating and sending interrupt notification 418 to energy transaction execution engine 402. Interrupt notification 418 is a message indicating that an event or condition of charging process 404 violates energy transaction plan 410. For example, a user 414 may specify in energy transaction plan 410 a maximum acceptable price per kilowatt-hour that user 414 is willing to pay. If during charging process 404, energy transaction interrupt monitor 416 detects that electric vehicle 406 is receiving electricity at a rate in excess of the maximum acceptable price, then energy transaction interrupt monitor 416 sends interrupt notification 418 to energy transaction execution engine 402. In response to receiving interrupt notification 418 energy transaction execution engine 402 may terminate charging process 404.

If charging process 404 is terminated by energy transaction execution engine 402 as a result of receiving interrupt notification 418, then in one embodiment energy transaction execution engine 402 may generate and transmit to various components of system 400 incomplete charge notification 420. Incomplete charge notification 420 is a message providing information related to the premature termination of charging process 404. For example, incomplete charge notification 420 may be transmitted to user 414 and may include a message that charging process 404 has terminated, the reason for termination, and that electric vehicle 406 may be disconnected from charging station 408. In this example, incomplete charge notification 420 may be presented to user 414 on a remote computing device, such as a cell phone, personal digital assistant, or computer. Incomplete charge notification 420 may be presented to user 414 on a display in electric vehicle 406 or on a display located at charging station 408. In addition, incomplete charge notification 420 may be presented to any other person, such as an attendant located at charging station 408.

Energy transaction execution engine 402 may also present incomplete charge notification 420 to energy transaction broker 422. Energy transaction broker 422 is an energy transaction broker, such as energy transaction broker 314 in FIG. 3. More specifically, energy transaction broker 422 is a software component for settling charging process 404. Energy transaction broker 422 settles charging process 404 by performing predefined tasks, such as for example, identifying the parties to whom money is owed, calculating an amount of payment owed to each party, and determining which funds are accessible for payment. If energy transaction broker 422 used energy transaction plan 410 for settling charging process 404, user 414 may be charged for electricity that was not received. In addition, user 414 may be improperly awarded with benefits or incentives that were not earned. Thus, when presented to energy transaction broker 422, incomplete charge notification 420 may include the details of charging process 404 as executed, as opposed to the original guidelines set forth in energy transaction plan 410. For example, if electric vehicle was supposed to have received an eight-hour charge according to energy transaction plan 410, but the charging process was terminated after electric vehicle 406 received a four hour charge, then incomplete charge notification 420 would inform energy transaction broker 422 that only the four hour charge was received. Consequently, user 414 would be charged for only the electricity received.

If after incomplete charge notification 420 has been transmitted, energy transaction execution engine 402 determines that electric vehicle 406 has not been disconnected from charging station 408, then energy transaction execution engine 402 may send request 424 to energy transaction planner 412. Request 424 is a request seeking from energy transaction planner 412 modified energy transaction plan 426. Modified energy transaction plan 426 is an energy transaction plan generated after charging process 404 has terminated because of a violation of energy transaction plan 410. Energy transaction planner 412 may generate modified energy transaction plan 426 based on an amount of electricity received in the previous charging process. For example, energy transaction planner 412 may create modified energy transaction plan 426 to include a new charging period based upon an amount of electricity that has already been received in the previously terminated charging process.

Thus, if electric vehicle 406 has already received four hours of electricity instead of the eight hours specified in energy transaction plan 410, then energy transaction planner 412 may modify the charging period of modified energy transaction plan 426 to specify a charging period of four hours. In another embodiment, energy transaction execution engine 402 may forward request 424 to user 414 for requesting user 414 to provide the new charging parameters. In this embodiment, energy transaction execution engine 402 may forward request 424 to user 414 via remote energy transaction alteration service 428.

Remote energy transaction alteration service 428 is a software component operable by user 414 for providing new parameters to generate modified energy transaction plan 426. Remote energy transaction alteration service 428 may be accessible to user 414 on a remote computing device. The remote computing device may be, for example, a smart phone, personal digital assistant, cell phone, laptop computer, or any other computing device. In addition, remote energy transaction alteration service 428 may be accessible to user 414 from the Internet via a web service. Thus, in one example, a user may generate new charging parameters in the event that charging process 404 has been prematurely terminated. In another example, user 414 may elect to generate modify energy transaction plan 410 in order to accommodate a change of travel plans. For example, energy transaction plan 410 may be a default energy transaction plan for user 414. Energy transaction plan 410 may be configured to enable electric vehicle 406 to receive sufficient electricity during a workday to allow user 414 to travel home from the office.

However, if on a particular day user 414 needs to run an errand immediately after work, electric vehicle 406 may require additional electricity for traveling the extra distance. Consequently, user 414 may utilize remote energy transaction alteration service 428 for generating modified energy transaction plan 426. User 414 invokes remote energy transaction alteration service 428 and modifies the parameters of energy transaction plan 410. Remote energy transaction alteration service 428 may then transmit the new parameters to energy transaction planner 412 for generating a new energy transaction plan. Furthermore, energy transaction interrupt monitor 416 may detect the newly generated parameters transmitted from remote energy transaction alteration service 428 and notify energy transaction execution engine 402 of the need to terminate a currently executing charging process.

If energy transaction interrupt monitor 416 does not detect an event or condition that would violate energy transaction plan 410, then energy transaction interrupt monitor 416 allows charging process 404 to proceed to completion. Once charging process 404 has completed without interruption, energy transaction interrupt monitor 416 may send energy transaction execution engine 402 a notification that the charging process has successfully completed. Energy transaction execution engine 402 may then generate completed charge notification 430 for transmission. Completed charge notification 430 is a message that may include the details of energy transaction plan 410. Thus, energy transaction execution engine 402 may present completed charge notification 430 to energy transaction broker 422 for settling the charging process. In addition, completed charge notification 430 may include a message to user 414 notifying user 414 that charging process 404 has been completed and that electric vehicle 406 may be disconnected from charging station 408. For example, completed charge notification 430 may be presented to user 414 on a remote computing device or on a display in electric vehicle 406. In addition, completed charge notification 430 may be presented to third parties, such as an attendant working at charging station 408.

Charging process data 432 is data generated during charging process 404. Charging process data 432 may include information such as, for example, user identifiers, third party identifiers, dates of charging, amounts of electricity consumed during each charging process, amount of electricity provided to the power grid, an amount charged for each charging process, or any other type of information that may be derived from a charging process. Charging process data 432 may be stored for subsequent processing. For example, charging process data 432 may be mined and/or processed for generating audits of a charging process.

Charging process data 432 may be stored in data storage device 434. Data storage device 434 is a device for storing data. Data storage device 434 may be, for example, a hard drive, flash memory, main memory, read only memory (ROM), random access memory (RAM), a magnetic or optical disk drive, tape, or any other type of data storage device. Data storage device 434 may be implemented in a single storage device or a plurality of storage devices.

In an illustrative embodiment, user 414 and other parties to the charging process agree to terms of energy transaction plan 410. Thereafter, once user 414 connects electric vehicle 406 with charging station 408, energy transaction planner 412 transmits energy transaction plan 410 to energy transaction execution engine 402. Upon receiving energy transaction plan 410, energy transaction execution engine 402 initiates charging process 404 between electric vehicle 406 and charging station 408. Energy transaction execution engine 402 may initiate charging process 404 by sending an instruction to charging station 408 to begin the transfer of electricity with electric vehicle 406. In addition, during charging process 404, or immediately after termination of charging process 404, energy transaction execution engine 402 collects and stores charging process data 432 in data storage device 434.

Concurrently, with the initiation of charging process 404, energy transaction execution engine 402 requests the services of energy transaction interrupt monitor 416. Energy transaction interrupt monitor 416 monitors charging process 404 to insure that charging process 404 proceeds in accordance with the terms of energy transaction plan 410. If energy transaction interrupt monitor 416 does not detect a condition of the charging process that violates energy transaction plan 410, then charging process 404 is permitted to proceed to completion. Thereafter, energy transaction interrupt monitor 416 may send energy transaction execution engine 402 a notification that the charging process has successfully terminated according to energy transaction plan 410. Energy transaction execution engine 402 then generates completed charge notification 430. Energy transaction execution engine 402 may send completed charge notification 430 to energy transaction broker for settling charging process 404. Energy transaction execution engine 402 may also sent completed charge notification 430 to user 414 to notify user 414 that charging process 404 has successfully completed and that electric vehicle 406 may be disconnected from charging station 408.

In the event that energy transaction interrupt monitor 416 detects an event or condition that violates energy transaction plan 410, energy transaction interrupt monitor 416 generates interrupt notification 418. Energy transaction interrupt monitor 416 sends interrupt notification 418 to energy transaction execution engine 402 to terminate charging process 404. In response to receiving interrupt notification 418, energy transaction execution engine 402 generates incomplete charge notification 420. Energy transaction execution engine 402 may send incomplete charge notification 420 to energy transaction broker 422 to settle charging process 404. In addition, energy transaction execution engine 402 may send incomplete charge notification 420 to user 414 to notify user 414 that electric vehicle 406 may be disconnected from charging station 408.

If energy transaction execution engine 402 determines that electric vehicle 406 has not been disconnected from charging station 408, then energy transaction execution engine 402 may then send request 424 to energy transaction planner 412 to request energy transaction planner 412 to generate modified energy transaction plan 426. Energy transaction planner 412 may generate modified energy transaction plan 426 or may request user 414 to provide parameters for generating modified energy transaction plan 426. User 414 may provide the new parameters for modified energy transaction plan 426 by using remote energy transaction alteration service 428.

In another example, user 414 may decide to alter energy transaction plan 410 during charging process 404. In this event, user 414 may access remote energy transaction alteration service 428 and provide new parameters to energy transaction planner 412 to generate modified energy transaction plan 426. Energy transaction interrupt monitor 416 detects the communication between remote energy transaction alteration service 428 and energy transaction planner 412 and generates interrupt notification 418. Energy transaction interrupt monitor 416 sends interrupt notification 418 to energy transaction execution engine 402 to terminate charging process 404. Energy transaction execution engine 402 may then reinitiate charging process 404 according to the terms of modified energy transaction plan 426.

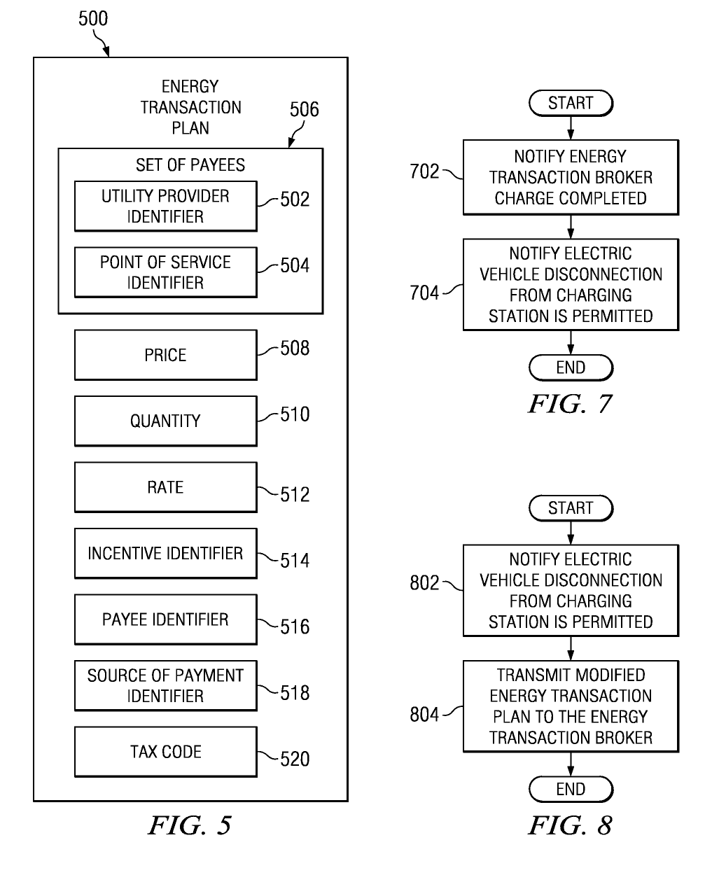

FIG. 5 is a block diagram of an energy transaction plan in accordance with an illustrative embodiment. Energy transaction plan 500 is an example of one implementation of an energy transaction plan, such as energy transaction plan 410 in FIG. 4.

Energy transaction plan 500 includes data usable by an energy transaction broker, such as energy transaction broker 422 in FIG. 4, for calculating a payment owed to a set of payees. Energy transaction plan 500 includes utility provider identifier 502. Utility provider identifier 502 is a unique identifier assigned to a utility provider from which electricity was received or to which electricity was sent.

Energy transaction plan 500 also includes point of service identifier 504. Point of service identifier 504 is a unique identifier assigned to a point of service provider participating in a charging transaction. A point of service provider is an entity providing a charging station at which a charging transaction is allowed to occur.

The entities associated with utility provider identifier 502 and point of service identifier 504 are entities to which payment is owed. Consequently, those entities may form set of payees 506. Set of payees 506 is one or more entities participating in the charging transaction. Set of payees may include, for example, a utility company, a point of service entity providing a charging station, a government entity specifying a tax applicable to a charging transaction, or any other party participating in a charging transaction.

Price 508 is a total cost of electricity owed as a result of a charging transaction. Price 508 may be calculated based upon quantity 510 and rate 512. Quantity 510 is an amount of electricity that was transferred during a charging transaction. Quantity 510 may be specified in kilowatt-hours. Rate 512 is a per unit cost of electricity. For example, rate 512 may specify a cost of electricity per kilowatt-hour.

Incentive identifier 514 is a set of one or more unique identifiers associated with an incentive fund applicable to the charging transaction described by energy transaction plan 500. The incentive fund is a fund from which money is taken to pay for a charging process. The incentive fund may be established by a party other than the payer. The incentive fund may offset the amount of payment owed to set of payees 506 by a user of identified by payee identifier 516. An energy transaction broker, such as energy transaction broker 422 in FIG. 4 may reference incentive identifier 514 for identifying an incentive fund for use in satisfying a payment owed to a set of payees.

Payee identifier 516 is a unique identifier for identifying the user of an electric vehicle from whom payment is owed for a charging transaction. Source of payment identifier 518 is an identifier associated with the source from which a payment may be made. The source may be, for example, a unique identifier specifying a bank account from which payer funds may be applied.

Tax code 520 is one or more codes for identifying any applicable taxes that may be applied to a charging transaction. For example, tax code 520 may specify an applicable sales or excise tax applicable to a charging transaction. Tax code 520 may be specified by a city, state, or federal tax law.

Energy transaction plan 500 may be referenced by an energy transaction execution engine, such as energy transaction execution engine 402 in FIG. 4 for managing a charging process of an electric vehicle.

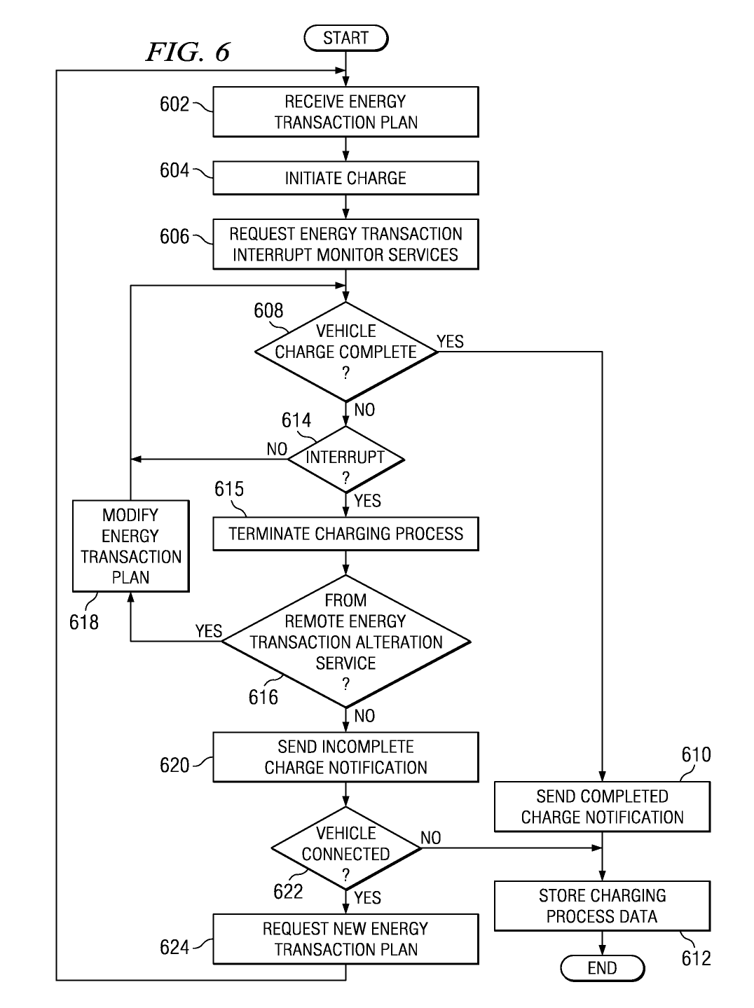

FIG. 6 is a flowchart of a process for executing an energy transaction plan in accordance with an illustrative embodiment. The process in FIG. 6 may be implemented in a software component such as energy transaction execution engine 402 in FIG. 4.

The process begins by receiving an energy transaction plan (step 602). The energy transaction plan may be received from an energy transaction planner such as energy transaction planner 310 in FIG. 3. The process then initiates a charging process with an electric vehicle (step 604). In one embodiment, the charging process may be initiated by sending a command to a charging station to which the electric vehicle is attached. In response to receiving the command, the charging station may trigger the exchange of electricity with the electric vehicle.

The process requests energy transaction interrupt monitor services (step 606). The energy transaction interrupt monitor is an energy transaction interrupt monitor, such as energy transaction interrupt monitor 320 in FIG. 3. The energy transaction interrupt monitor monitors the charging process initiated at step 604. The charging process is a charging process such as charging process 318 in FIG. 3.

Thereafter, the process then makes the determination as to whether the charging process is complete (step 608). If the process makes the determination that the charging process is complete, then the process sends a completed charge notification for transmission (step 610). The process then stores the charging process data (step 612) and terminates thereafter.

Returning now to step 608, if the process makes the determination that the vehicle charge is not complete, then the process makes the determination as to whether an interruption is detected (step 614). If an interruption is not detected, then the process returns to step 608. However, if the process makes the determination that an interruption is detected, then the process terminates the charging process (step 615) and makes the determination as to whether the interruption is from a remote energy transaction alteration service (step 616).

If the process makes the determination that the detected interruption is from a remote energy transaction alteration service, then the process modifies the energy transaction plan (618) and returns to step 608. If the process makes the determination that the detected interruption is not from a remote energy transaction alteration service, then the process sends incomplete charge notification (step 620).

The process then makes the determination as to whether the electric vehicle is still connected to the charging station (step 622). If the electric vehicle is no longer connected to the charging station, then the process continues to step 612. However, if the process makes the determination that the electric vehicle is still connected to the charging station, then the process requests a new energy transaction plan (step 624) and returns to step 602. The new energy transaction plan may be requested from an energy transaction planner such as energy transaction planner 310 in FIG. 3.

FIG. 7 is a flowchart of a process for sending a completed charge notification in accordance with an illustrative embodiment. The process in FIG. 7 may be performed by a software component such as energy transaction execution engine 402 in FIG. 4.

The process begins by notifying an energy transaction broker of a completed charge (step 702). The energy transaction broker is an energy transaction broker, such as energy transaction broker 314 in FIG. 3. The process then notifies the electric vehicle that disconnection from the charging station is permitted (step 704) and the process terminates.

FIG. 8 is a flowchart of a process for transmitting an incomplete charge notification in accordance with an illustrative embodiment. The process in FIG. 8 may be performed by a software component, such as energy transaction execution engine 402 in FIG. 4.

The process begins by notifying an electric vehicle that disconnection from the charging station is permitted (step 802). The process then transmits a modified energy transaction plan to the energy transaction broker (step 804) and the process terminates.

According to one embodiment, a computer implemented method, apparatus, and computer usable program code is provided for managing a charging process of an electric vehicle. In one embodiment, the process initiates the charging process of the electric vehicle at a charging station in response to receiving an energy transaction plan from an energy transaction planner. The process then terminates the charging process in response to at least one of a deviation of the charging process from the energy transaction plan and a completion of the charging process according to the energy transaction plan. Thereafter, the process sends a charge notification to a set of recipients that includes a user of the electric vehicle and an energy transaction broker.

The illustrative embodiments discuss an energy transaction execution engine that governs the execution of an energy transaction plan for an electric vehicle charging process. The energy transaction execution engine initiates and terminates the charging process using inputs received from other components of an electric vehicle transaction infrastructure. In addition, energy transaction execution engine transmits messages throughout the electric vehicle transaction infrastructure. Energy transaction execution engine acts as a centralized component that manages the input from other components of the charging infrastructure and insures that the charging process proceeds according to the agreed upon transaction parameters specified in the energy transaction plan. In some instances, energy transaction execution engine may be required to prematurely terminate a charging process and initiate a modified energy transaction plan that better comports with the preferences of the parties to the charging process.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of managing a charging process of an electric vehicle, the computer implemented process comprising:
responsive to receiving an energy transaction plan from an energy transaction planner initiating the charging process of the electric vehicle at a charging station;
responsive to at least one of a deviation of the charging process from the energy transaction plan and a completion of the charging process according to the energy transaction plan, terminating the charging process; and
sending a charge notification to a set of recipients, wherein the set of recipients comprises a user of the electric vehicle and an energy transaction broker.

2. The computer implemented method of claim 1, further comprising:
detecting, by a energy transaction interrupt monitor, the at least one of the deviation of the charging process from the energy transaction plan and the completion of the charging process according to the energy transaction plan.

3. The computer implemented method of claim 1, further comprising:
storing charging process data in a data storage device wherein the charging process data is generated during the charging process.

4. The computer implemented method of claim 1, further comprising:
responsive to terminating the charging process due to the deviation of the charging process from the energy transaction plan, generating a request for a modified energy transaction plan.

5. The computer implemented method of claim 4 further comprising:
sending the request to a user via a remote energy transaction alteration service, wherein the user provides input for generating the modified energy transaction plan.

6. The computer implemented method of claim 4, wherein the modified energy transaction plan is generated by the energy transaction planner, and further comprising:
selecting terms of the modified energy transaction plan, by the energy transaction planner, wherein the charging process is completed according to the terms of the modified energy transaction plan.

7. The computer implemented method of claim 1, wherein the charge notification is at least one of a completed charge notification and an incomplete charge notification.

8. A computer program product for managing a charging process of an electric vehicle, the computer program product comprising:
a computer-recordable storage media;
first program instructions to initiate the charging process of the electric vehicle at a charging station in response to receiving an energy transaction plan from an energy transaction planner;
second program instructions to terminate the charging process in response to at least one of a deviation of the charging process from the energy transaction plan and a completion of the charging process according to the energy transaction plan;
third program instructions to send a charge notification to a set of recipients, wherein the set of recipients comprises a user of the electric vehicle and an energy transaction broker; and
wherein the first program instructions, the second program instructions, and the third program instructions are stored on the computer readable medium.

9. The computer program product of claim 8, wherein an energy transaction interrupt monitor detects the at least one of the deviation of the charging process from the energy transaction plan and the completion of the charging process according to the energy transaction plan.

10. The computer program product of claim 8, further comprising:
fourth program instructions to store charging process data in a data storage device, wherein the charging process data is generated during the charging process.

11. The computer program product of claim 8, further comprising:
fifth program instructions to generate a request for a modified energy transaction plan in response to terminating the charging process due to the deviation of the charging process from the energy transaction plan.

12. The computer program product of claim 11, wherein the request is sent to a user via a remote energy transaction alteration service, and wherein the user provides input for generating the modified energy transaction plan.

13. The computer program product of claim 11, wherein the modified energy transaction plan is generated by the energy transaction planner, and wherein terms of the modified energy transaction plan are selected for completing the charging process according to the energy transaction plan.

14. The computer program product of claim 8, wherein the charge notification is at least one of a completed charge notification and an incomplete charge notification.

15. An apparatus for managing a charging process of an electric vehicle, the apparatus comprising:
a bus system;
a memory connected to the bus system, wherein the memory includes computer usable program code; and
a processing unit connected to the bus system, wherein the processing unit executes the computer usable program code to initiate the charging process of the electric vehicle at a charging station in response to receiving an energy transaction plan from an energy transaction planner; terminate the charging process in response to at least one of a deviation of the charging process from the energy transaction plan and a completion of the charging process according to the energy transaction plan; and send a charge notification to a set of recipients, wherein the set of recipients comprises a user of the electric vehicle and an energy transaction broker.

16. The apparatus of claim 15, wherein the processing unit further executes the computer usable program code to detect the at least one of the deviation of the charging process from the energy transaction plan and the completion of the charging process according to the energy transaction plan.

17. The apparatus of claim 15 wherein the processing unit further executes the computer usable program code to generate a request for a modified energy transaction plan in response to terminating the charging process due to the deviation of the charging process from the energy transaction plan.

18. The apparatus of claim 17, wherein the request is sent to a user via a remote energy transaction alteration service, and wherein the user provides input for generating the modified energy transaction plan.

19. The apparatus of claim 17, wherein the modified energy transaction plan is generated by the energy transaction planner, and wherein terms of the modified energy transaction plan are selected for completing the charging process according to the energy transaction plan.

20. A system for managing a charging process of an electric vehicle, the system comprising:
an energy transaction planner, wherein the energy transaction planner generates an energy transaction plan for the charging process;
an energy transaction interrupt monitor, wherein the energy transaction interrupt monitor detects at least one of a deviation of the charging process from the energy transaction plan and a completion of the charging process according to the energy transaction plan; and
an energy transaction execution engine, wherein the energy transaction execution engine initiates the charging process of the electric vehicle at a charging station in response to receiving an energy transaction plan from an energy transaction planner; terminates the charging process in response to the at least one of the deviation of the charging process from the energy transaction plan and the completion of the charging process according to the energy transaction plan; and sends a charge notification to a set of recipients, wherein the set of recipients comprises a user of the electric vehicle and an energy transaction broker.
